(19) United States
(12) Patent Application Publication
(10) Pub. No.: US 2011/0028326 A1
(43) Pub. Date: Feb. 3, 2011

(54) COMPOSITIONS AND METHODS FOR PROVIDING PLANT GROWTH REGULATION

(76) Inventor: Kenneth L. Dart, Wenatchee, WA (US)

Correspondence Address: LEFFERT JAY & POLGLAZE, P.A., P.O. BOX 581009, MINNEAPOLIS, MN, 55458-1009, US

(21) Appl. No.: 12/512,668

(22) Filed: Jul. 30, 2009

(51) Int. Cl. A01N 43/08; A01N 43/90; A01P 21/00

(52) U.S. Cl. 504/241; 504/297

(57) ABSTRACT

Compositions containing one or more plant growth regulators other than prohexadione calcium and one or more metal phosphites are suitable for providing growth regulation when applied to agricultural crops while providing micronutrients for plant health.

### TECHNICAL FIELD

The present invention relates generally to providing micronutrients to agricultural crops in conjunction with plant growth regulation, and in particular, in one or more embodiments, the present disclosure relates to compositions and use of metal phosphites with plant growth regulators other than prohexadione calcium.

### BACKGROUND

Plant growth regulators are widely used in the tree fruit industry to produce a variety of desirable changes in the growing cycle of the fruit. For example, 6-benzyladenine (6BA) is a cytokinin analog commonly used to thin fruitlets as well as to enhance cell division, leading to increases in fruit size. Giberellic acid 4, 7 (GA₄₊₇) is commonly used to control the development of physiological russeting of Golden Delicious apples in years when russeting conditions are present. In addition, GA₄₊₇ and 6BA may be used in combination to improve fruit size and shape. Other plant growth regulators are also known. In general, however, plant growth regulators tend to be complex molecules that are difficult to get into the tissue of the plant.

To increase efficacy, plant growth regulators such as GA₄₊₇ and 6BA are generally applied as neutral to acidic solutions, having a pH in the range of 5-7 for example. To maintain the solutions in the desired pH range, phosphate- or magnesium-based buffers are often used.

For the reasons stated above, and for other reasons which will become apparent to those skilled in the art upon reading and understanding the present specification, there is a need in the art for alternative approaches to providing plant growth regulation in crops.

### DETAILED DESCRIPTION

In the following detailed description of the present embodiments, the embodiments are described in sufficient detail to enable those skilled in the art to practice the invention, and it is to be understood that other embodiments may be utilized and that process, chemical, or mechanical changes may be made without departing from the scope of the present disclosure. The following detailed description is, therefore, not to be taken in a limiting sense.

To address the desire to increase efficacy of plant growth regulators, various embodiments employ metal phosphites mixed with the plant growth regulator to produce a neutral to acidic solution. Example metal phosphites include calcium phosphite (CaHPO₃), copper phosphite (CuHPO₃), manganese phosphite (MnHPO₃), magnesium phosphite (MgHPO₃) and zinc phosphite (ZnHPO₃). Such metal phosphites may be produced, for example, through the reaction of a metal carbonate with phosphorous acid. For example, a reaction product of calcium carbonate and phosphorous acid is calcium phosphite.

Phosphites have been shown to increase nutrient uptake into plant tissues. As the efficacy of plant growth regulators is generally a function of the relative absorption of the plant growth regulator into the tissue of the plant, it is believed that the systemic action of phosphites can also be used to improve the translocation of these complex molecules and increase their efficacy. Further, as these metal phosphites tend to be quite acidic, they serve the dual purpose of lowering the pH of the solution containing the plant growth regulator. If the pH is reduced to a level not recommended by a manufacturer of the plant growth regulator, or to a level otherwise undesirable, buffers could be used to bring the pH of the solution back up to the desired range.

In addition, as plant growth regulators are applied during growth stages of the plant, micronutrients are often desirable at the time of application of the plant growth regulator. As calcium, copper, manganese, magnesium and zinc are known micronutrients, use of phosphites containing these metals facilitates the added benefit of providing the associated micronutrient during application of the plant growth regulator. For example, select plant growth regulators increase cell division. As calcium supports cell division, this increase leads to additional calcium demand due to the application of such plant growth regulators. By combining calcium phosphite with such plant growth regulators, such embodiments facilitate calcium delivery in combination with delivery of the plant growth regulator at a time when the plant has a heightened demand.

In accordance with the disclosure herein, various embodiments employ aqueous compositions containing one or more metal phosphites and one or more plant growth regulators other than prohexadione calcium [calcium 3-oxido-5-oxo-4-propionylcyclohex-3-enecarboxylate]. Applicant is a co-inventor of U.S. patent application Ser. No. 12/262,834, filed Oct. 31, 2008 and titled, “COMPOSITIONS AND METHODS FOR PROVIDING MICRONUTRIENTS IN CONJUNCTION WITH PLANT GROWTH REGULATION.”U.S. patent application Ser. No. 12/262,834 discloses the use of metal phosphites with prohexadione calcium. The present application addresses plant growth regulators other than prohexadione calcium.

Compositions in accordance with various embodiments may further contain additional chemical components that do not materially affect the basic and novel properties of the compositions disclosed herein. Some examples include dyes, stabilizers, buffers, conditioners, surfactants, preservatives, organic materials, other fertilizers (other than metal phosphites), herbicides, fungicides and insecticides. Compositions in accordance with various embodiments should be foliar applied, such as by using a boom spray, an air blaster or the like.

The compositions should contain an efficacious amount of the plant growth regulator(s) other than prohexadione calcium to provide for a desired level or nature of growth regulation and an efficacious amount of metal phosphites to produce a neutral to acidic solution while providing micronutrients for promoting plant health. For example, compositions in accordance with various embodiments of this disclosure may include aqueous solutions containing 1-10% of one or more metal phosphites, measured on a metal basis, and 1-5% of the plant growth regulator(s) other than prohexadione calcium, measured on an active ingredient basis. While such concentrations are believed to be appropriate for ease of manufacturing and economy in transportation, these compositions may be combined with additional water prior to application. When referring to concentrations herein, percentages refer to weight percentages unless otherwise noted. Furthermore, weights and concentrations of the metal phosphites and the like, unless otherwise noted, are determined on a metal basis, i.e., the phosphite anion (HPO₃) is not considered in calculating weight or concentration of the metal phosphite, as the corresponding metals are the desired micronutrients.

Alternatively, compositions in accordance with various embodiments of this disclosure include aqueous solutions containing one or more plant growth regulators other than prohexadione calcium and an amount of one or more metal phosphites to provide application rates in the range of approximately 4-700 g/acre (0.01-1.7 kg/hectare) of any one metal phosphite, measured on a metal basis, without exceeding a manufacturer's maximum recommended application rate of any of the one or more plant growth regulators of the aqueous solution. As used herein, the manufacturer's maximum recommended application rate is the application rate of a particular plant growth regulator that a manufacturer of that particular plant growth regulator recommends not be exceeded for any stated purpose. For a further embodiment, such solutions contain an amount of the one or more metal phosphites to provide application rates in the range of approximately 4-700 g/acre (0.01-1.7 kg/hectare) of any one metal phosphite, measured on a metal basis, while permitting an application rate of any one of the one or more plant growth regulators of the solution equal to or less than a manufacturer's maximum recommended application rate and equal to or greater than a manufacturer's minimum recommended application rate. As used herein, the manufacturer's minimum recommended application rate is the application rate of a particular plant growth regulator that a manufacturer of that particular plant growth regulator recommends as a minimum application rate for any stated purpose.

Amounts of the plant growth regulators in such compositions may depend upon the desired application rate of the plant growth regulators. For example, typical application rates of 6BA may be in the range of 3-75 g/acre (0.007-0.19 kg/hectare) of the active ingredient while typical application rates of GA₄₊₇ may be in the range of 3-20 g/acre (0.007-0.05 kg/hectare) of the active ingredient. Thus, for these examples, the compositions may include aqueous solutions containing 0.05-230 grams of one or more metal phosphites, measured on a metals basis, for every 1 gram of 6BA, or aqueous solutions containing 0.2-230 grams of one or more metal phosphites, measured on a metals basis, for every 1 gram of GA₄₊₇. Further embodiments may include aqueous solutions containing 1.5-10 grams of one or more metal phosphites, measured on a metals basis, for every 1 gram of 6BA, or aqueous solutions containing 1.5-35 grams of one or more metal phosphites, measured on a metals basis, for every 1 gram of GA₄₊₇. Such embodiments would facilitate desirable application rates of the metal phosphites at the typical application rates of these plant growth regulators.

Additional embodiments include aqueous solutions containing one or more plant growth regulators other than prohexadione calcium and an amount of one or more metal phosphites to provide a solution pH of 7 or less. Further embodiments include aqueous solutions containing one or more plant growth regulators other than prohexadione calcium and an amount of one or more metal phosphites to provide a solution pH in a range of 5-7.

Methods of treating agricultural crops in accordance with various embodiments include applying solutions containing one or more metal phosphites and one or more plant growth regulators other than prohexadione calcium to the crop, e.g., apples. The treatment of a crop can be a single application or multiple applications of solutions in accordance with various embodiments. In general, single applications would utilize a higher concentration of plant growth regulators than multiple, or split, applications for similar results. Broadcast application, e.g., foliar application, is generally advised.

Although specific embodiments have been illustrated and described herein, it will be appreciated by those of ordinary skill in the art that any arrangement that is calculated to achieve the same purpose may be substituted for the specific embodiments shown. Many adaptations of the disclosure will be apparent to those of ordinary skill in the art. Accordingly, this application is intended to cover any adaptations or variations of the disclosure.

What is claimed is:

1. A method of treating agricultural crops, comprising:
applying an aqueous solution to a crop, wherein the aqueous solution comprises one or more plant growth regulators other than prohexadione calcium and one or more metal phosphites;
wherein the one or more metal phosphites are selected from the group consisting of zinc phosphite, manganese phosphite, magnesium phosphite, calcium phosphite, iron phosphite and copper phosphite.

2. The method of claim 1, wherein applying the aqueous solution comprises applying the aqueous solution at a rate to provide an amount of the one or more plant growth regulators that is efficacious for growth regulation of the crop.

3. The method of claim 1, wherein applying the aqueous solution comprises applying the aqueous solution having an amount of the one or more of the metal phosphites sufficient to produce a solution pH of 7 or less.

4. The method of claim 1, wherein applying the aqueous solution comprises applying the aqueous solution having an amount of the one or more of the metal phosphites sufficient to produce a solution pH in a range of 5-7.

5. The method of claim 1, wherein applying the aqueous solution comprises applying the aqueous solution comprising 0.05-230 grams of one or more of the metal phosphites, measured on a metal basis, for every 1 gram of any one of the one or more plant growth regulators, measured on an active ingredient basis.

6. The method of claim 1, wherein applying the aqueous solution comprises applying the aqueous solution to provide 4-700 g/acre of one or more of the metal phosphites, measured on a metal basis.

7. The method of claim 6, wherein applying the aqueous solution further comprises applying the aqueous solution to provide 3-75 g/acre of 6-benzyladenine as at least one of the plant growth regulators.

8. The method of claim 6, wherein applying the aqueous solution further comprises applying the aqueous solution to provide 3-20 g/acre of giberellic acid 4, 7 as at least one of the plant growth regulators.

9. The method of claim 1, wherein applying the aqueous solution comprises applying the aqueous solution using a broadcast application method.

10. The method of claim 1, wherein applying the aqueous solution comprises applying the aqueous solution comprising one or more plant growth regulators other than prohexadione calcium, one or more metal phosphites and one or more additional components selected from the group consisting of dyes, stabilizers, buffers, conditioners, surfactants, preservatives, organic materials, fertilizers other than metal phosphites, herbicides, fungicides and insecticides.

11. The method of claim 1, wherein applying the aqueous solution comprises applying the aqueous solution to apple trees.

12. An aqueous solution for treatment of agricultural crops, comprising:
one or more plant growth regulators other than prohexadione calcium; and
one or more metal phosphites;
wherein the one or more metal phosphites are selected from the group consisting of zinc phosphite, manganese phosphite, magnesium phosphite, calcium phosphite, iron phosphite and copper phosphite.

13. The aqueous solution of claim 12, wherein the aqueous solution comprises 1-10% by weight of the one or more of the metal phosphites, measured on a metal basis, and 1-5% by weight of the one or more plant growth regulators, measured on an active ingredient basis.

14. The aqueous solution of claim 12, wherein at least one of the metal phosphites is calcium phosphite.

15. The aqueous solution of claim 12, wherein the aqueous solution comprises 0.05-230 grams of one or more of the metal phosphites, measured on a metal basis, for every 1 gram of any one of the one or more plant growth regulators.

16. The aqueous solution of claim 12, wherein the aqueous solution comprises an amount of the one or more of the metal phosphites sufficient to produce a solution pH of 7 or less.

17. The aqueous solution of claim 12, wherein the aqueous solution comprises an amount of the one or more of the metal phosphites sufficient to produce a solution pH in a range of 5-7.

18. An aqueous solution for treatment of agricultural crops, comprising:
one or more plant growth regulators other than prohexadione calcium; and
calcium phosphite.

19. The aqueous solution of claim 18, wherein the aqueous solution comprises 1-10% by weight of the calcium phosphite, measured on a metal basis, and 1-5% by weight of the one or more plant growth regulators, measured on an active ingredient basis.

20. The aqueous solution of claim 18, wherein the one or more plant growth regulators are selected from the group consisting of 6-benzyladenine and giberellic acid 4, 7.

21. The aqueous solution of claim 18, wherein the aqueous solution comprises 0.05-230 grams of calcium phosphite, measured on a metal basis, for every 1 gram of any one of the one or more plant growth regulators.

22. The aqueous solution of claim 18, wherein the aqueous solution comprises an amount of calcium phosphite sufficient to provide an application rate of 4-700 g/acre of calcium phosphite, measured on a metal basis, without exceeding a manufacturer's maximum recommended application rate of any one of the one or more plant growth regulators of the aqueous solution.

23. The aqueous solution of claim 18, further comprising one or more additional components selected from the group consisting of dyes, stabilizers, buffers, conditioners, surfactants, preservatives, organic materials, fertilizers other than metal phosphites, herbicides, fungicides and insecticides.
